(19) United States
(12) Patent Application Publication
(10) Pub. No.: US 2013/0250453 A1
(43) Pub. Date: Sep. 26, 2013

(54) PERPENDICULAR MAGNETIC RECORDING MEDIUM AND MAGNETIC RECORDING/REPRODUCTION APPARATUS

(71) Applicant: Takeshi IWASAKI, Inagi-shi (JP)

(72) Inventor: Takeshi IWASAKI, Inagi-shi (JP)

(73) Assignee: KABUSHIKI KAISHA TOSHIBA, Tokyo (JP)

(21) Appl. No.: 13/596,510

(22) Filed: Aug. 28, 2012

(30) Foreign Application Priority Data
Mar. 22, 2012 (JP) 2012-066393

(51) Int. Cl. G11B 5/65; G11B 17/02; G11B 5/667

(52) U.S. Cl. 360/99.08; 428/828; G9B/17.002; G9B/5.241; G9B/5.238

(57) ABSTRACT

According to one embodiment, a perpendicular magnetic recording medium including a soft magnetic under layer, a nonmagnetic seed layer consisting of AgGe, a nonmagnetic interlayer made of Ru or an Ru alloy, and a perpendicular magnetic recording layer, laminated on the nonmagnetic substrate is provided. The nonmagnetic seed layer is an layer containing Ag grains having an fcc structure and an amorphous Ge grain boundary, and the Ag grain surface is higher than the Ge grain boundary surface.

### CROSS-REFERENCE TO RELATED APPLICATIONS

This application is based upon and claims the benefit of priority from Japanese Patent Application No. 2012-066393, filed Mar. 22, 2012, the entire contents of which are incorporated herein by reference.

### FIELD

Embodiments described herein relate generally to a perpendicular magnetic recording medium and magnetic recording/reproduction apparatus.

### BACKGROUND

The present invention provides a magnetic recording medium having good recording/reproduction characteristics by transferring the grain structure of an AgGe seed layer having a low grain size distribution to a perpendicular magnetic recording layer, thereby suppressing the grain size distribution of magnetic grains and reducing the medium transition noise. The medium of this application includes at least a nonmagnetic substrate, soft magnetic under layer, nonmagnetic seed layer, nonmagnetic interlayer, and perpendicular magnetic recording layer. The nonmagnetic seed layer is made of AgGe, contains Ag grains having an fcc structure and a Ge grain boundary having an amorphous structure, and has a grain size distribution of 15% or less. The Ag grain has a feature that in the interface in the uppermost portion, the grain has a three-dimensional structure of 2 nm or more having a central portion of the grain as a projection and the grain boundary as a recess. The Ge content in the AgGe film is 55 (inclusive) to 70 (inclusive) at %. When compared to conventional formation methods, the AgGe film having a low grain size distribution can be obtained at a low Ar pressure.

### BRIEF DESCRIPTION OF THE DRAWINGS

FIG. 1 is a sectional view showing an example of a perpendicular magnetic recording medium according to the first embodiment;

FIG. 2 is a sectional view showing an example of a perpendicular magnetic recording medium according to the second embodiment;

FIG. 3 is a sectional view showing an example of a perpendicular magnetic recording medium according to the third embodiment;

FIG. 4 is a sectional view showing an example of a perpendicular magnetic recording medium according to the fourth embodiment;

FIG. 5 is an exemplary view showing an example of a magnetic recording/reproduction apparatus according to the fifth embodiment;

FIG. 6 is a sectional view showing another example of the perpendicular magnetic recording medium according to the first embodiment;

FIG. 7 is an exemplary view showing the sectional structure of a nonmagnetic seed layer; and

FIG. 8 is a graph showing the grain size distribution and SNR of the nonmagnetic seed layer as functions of the Ge content in the nonmagnetic seed layer.

### DETAILED DESCRIPTION

Embodiments will be explained below with reference to the accompanying drawings.

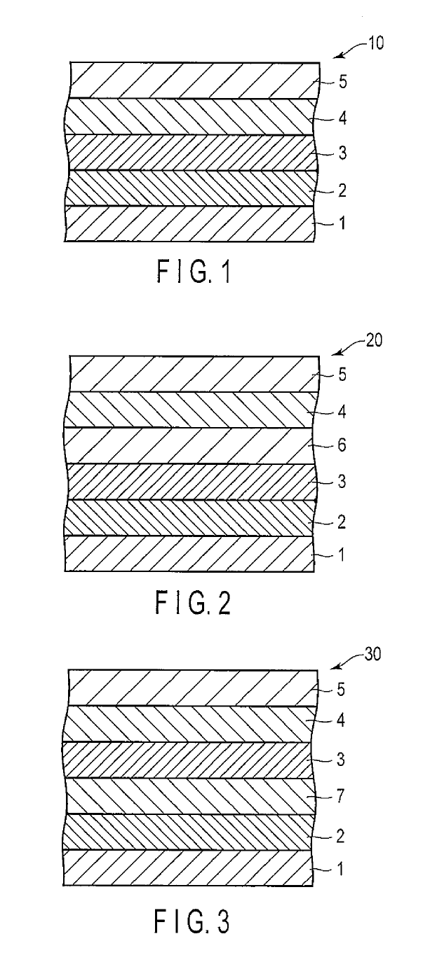

FIG. 1 is a sectional view showing an example of a perpendicular magnetic recording medium according to the first embodiment.

A perpendicular magnetic recording medium 10 according to the first embodiment includes a nonmagnetic substrate 1, a soft magnetic under layer 2 formed on the nonmagnetic substrate 1, a nonmagnetic seed layer 3 formed on the soft magnetic under layer 2, a nonmagnetic interlayer 4 formed on the nonmagnetic seed layer 3, and a perpendicular magnetic recording layer 5 formed on the nonmagnetic interlayer 4. The nonmagnetic seed layer 3 is an AgGe layer containing Ag grains having an fcc structure and an amorphous Ge grain boundary formed around the Ag grains, and the Ag grain surface is higher than the Ge grain boundary surface. The nonmagnetic interlayer 4 is made of Ru or an Ru alloy.

In the first embodiment, a perpendicular magnetic recording layer superior in grain size distribution and crystal orientation is obtained. This makes it possible to reduce the medium transition noise, and improve the recording/reproduction characteristics.

Note that “a main component” mentioned in this specification is a component or a combination of components whose content is relatively largest in the material composition.

The Ag grain surface can be higher by 2 nm or more than the Ge grain boundary surface. If the height of the Ag grain surface from the Ge grain boundary surface is less than 2 nm, the grain structure of the AgGe film cannot accurately be transferred to the upper nonmagnetic interlayer. That is, since the difference between the projection and recess is small, one grain (the nonmagnetic interlayer) cannot be placed on one Ag grain, and the grains of the nonmagnetic interlayer are freely generated by neglecting the grains and grain boundary.

The Ag grain surface can be higher by 2 to 3 nm than the Ge grain boundary surface. If the height of the Ag grain surface from the Ge grain boundary surface exceeds 3 nm, the medium surface becomes uneven because the roughness is large. Consequently, the floating position of a magnetic head rises, and a recording magnetic field from the magnetic head spreads or reduces, thereby generating a spacing loss.

The grain size distribution of the Ag grains can be 15% or less.

By using an AgGe film in which the Ag grain height is 2 nm or more and the Ag grains have a grain size distribution of 15% or less as the nonmagnetic seed layer, it is possible to well reduce the grain size distribution of the grains in the perpendicular magnetic recording layer, and provide a perpendicular magnetic recording medium having good recording/reproduction characteristics.

The Ge content in the nonmagnetic seed layer can be 55 to 70 at %.

If the Ge content is less than 55 at %, the grain boundary substance reduces, so the separation between the grains becomes insufficient, and a maize structure in which grains connect to each other often forms. If the Ge content exceeds 70 at %, the Ge amount is too large, so Ge mixes in the Ag grains and worsens the crystallinity of the grains, or a uniform AgGe film having an hcp structure instead of the Ag grains and Ge grain boundary forms.

The nonmagnetic seed layer can be an AgGe layer formed in an Ar gas ambient at an Ar pressure of 0.05 to 0.3 Pa.

If the Ar pressure is less than 0.05 Pa, deposition by sputtering often becomes unstable. If the Ar pressure exceeds 0.3 Pa, the grain size distribution worsens or the grain size increases because the impurity amount is large.

The perpendicular magnetic recording layer can contain Fe or Co and Pt as main components.

FIG. 2 is a sectional view showing an example of a perpendicular magnetic recording medium according to the second embodiment.

A perpendicular magnetic recording medium 20 according to the second embodiment has the same arrangement as that of the perpendicular magnetic recording medium 10 according to the first embodiment, except that a nonmagnetic underlayer 6 containing at least one element selected from the group consisting of Pd, Ta, Co, and Ni as a main component is further formed between a nonmagnetic seed layer 3 and nonmagnetic interlayer 4.

By using the nonmagnetic underlayer 6 containing an element selected from Pd, Ta, Co, and Ni as a main component, it is possible to further improve the grain size distribution of a perpendicular magnetic recording layer, and further improve the recording/reproduction characteristics.

FIG. 3 is a sectional view showing an example of a perpendicular magnetic recording medium according to the third embodiment.

A perpendicular magnetic recording medium 30 according to the third embodiment has the same arrangement as that of the perpendicular magnetic recording medium 10 according to the first embodiment, except that a nonmagnetic orientation control layer 7 containing at least one element selected from the group consisting of Ag, Pd, and Ru as a main component is further formed between a soft magnetic under layer 2 and nonmagnetic seed layer 3.

By using the nonmagnetic orientation control layer 7 containing an element selected from Ag, Pd, and Ru as a main component, it is possible to further improve the crystal orientation of a perpendicular magnetic recording layer, and further improve the recording/reproduction characteristics.

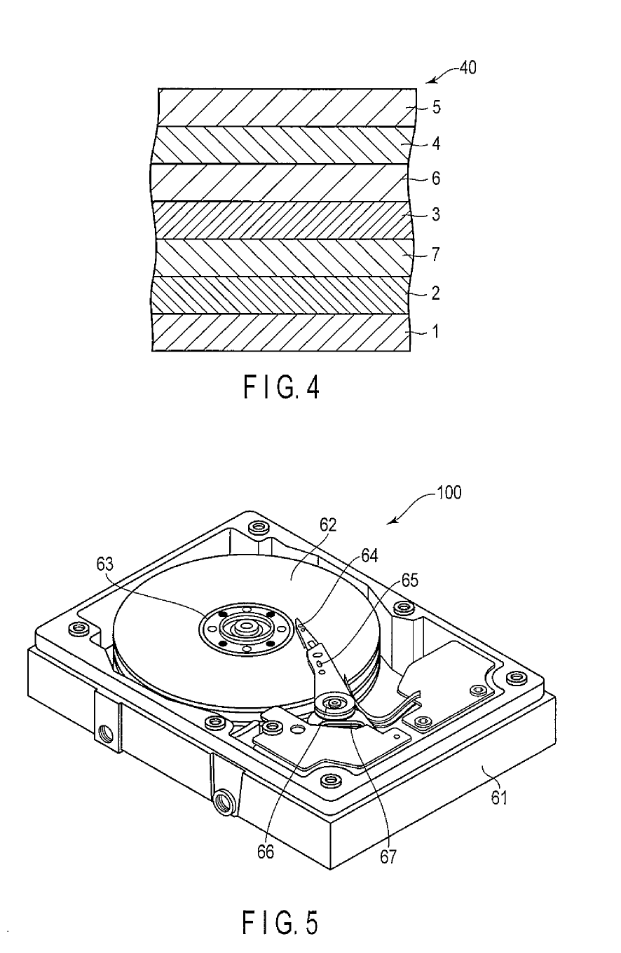

FIG. 4 is a sectional view showing an example of a perpendicular magnetic recording medium according to the fourth embodiment.

A perpendicular magnetic recording medium 40 according to the fourth embodiment has the same arrangement as that of the perpendicular magnetic recording medium 10 according to the first embodiment, except that a nonmagnetic underlayer 6 containing at least one element selected from the group consisting of Pd, Ta, Co, and Ni as a main component is further formed between a nonmagnetic seed layer 3 and nonmagnetic interlayer 4, and a nonmagnetic orientation control layer 7 containing at least one element selected from the group consisting of Ag, Pd, and Ru as a main component is further formed between a soft magnetic under layer 2 and the nonmagnetic seed layer 3.

By using the nonmagnetic underlayer 6 containing an element selected from Pd, Ta, Co, and Ni as a main component, and the nonmagnetic orientation control layer 7 containing an element selected from Ag, Pd, and Ru as a main component, it is possible to further improve the grain size distribution and crystal orientation of a perpendicular magnetic recording layer, and further improve the recording/reproduction characteristics. When these two layers are formed, however, a spacing loss readily occurs because the distance between a magnetic head and the soft magnetic under layer increases. Accordingly, these two layers must be formed by a minimum film thickness. For example, the total film thickness of the two layers is 5 (inclusive) to 20 (inclusive) nm. If the total film thickness of the two layers is less than 5 nm, the layers cannot sufficiently achieve their respective effects, and the characteristic improving effect becomes insufficient. If the film thickness of the two layers exceeds 20 nm, a spacing loss occurs, and the recording ability of a magnetic head decreases. As a consequence, the recording/reproduction characteristics tend to worsen.

A magnetic recording/reproduction apparatus according to an embodiment is a magnetic recording/reproduction apparatus using the above-mentioned perpendicular magnetic recording medium. This apparatus includes a perpendicular magnetic recording medium including a nonmagnetic substrate, a soft magnetic under layer formed on the nonmagnetic substrate, a nonmagnetic seed layer formed on the soft magnetic under layer, a nonmagnetic interlayer formed on the nonmagnetic seed layer, and a perpendicular magnetic recording layer formed on the nonmagnetic interlayer, a mechanism for supporting and rotating the perpendicular magnetic recording medium, a magnetic head including an element for recording information on the perpendicular magnetic recording medium and an element for reproducing recorded information, and a carriage assembly that supports the magnetic head such that the magnetic head can freely move with respect to the perpendicular magnetic recording medium. The nonmagnetic seed layer is an AgGe layer containing Ag grains having an fcc structure and an amorphous Ge grain boundary formed around the Ag grains, and the Ag grain surface is higher than the Ge grain boundary surface. The nonmagnetic interlayer is made of Ru or an Ru alloy.

FIG. 5 is an partially exploded perspective view showing an example of the magnetic recording/reproduction apparatus according to the embodiment.

The magnetic recording/reproduction apparatus according to the embodiment includes the above-mentioned perpendicular magnetic recording medium and a magnetic head.

In a magnetic recording/reproduction apparatus 100 according to the embodiment, a rigid magnetic disk 62 for information recording according to the embodiment is fitted on a spindle 63, and rotated at a predetermined rotational speed by a spindle motor (not shown). A slider 64 on which a recording head for recording information by accessing the magnetic disk 62 and an MR head for reproducing information are mounted is attached to the distal end of a suspension 65 formed by a thin leaf spring. The suspension 65 is connected to one end of an arm 66 including a bobbin for holding a driving coil (not shown).

A voice coil motor 67 as a kind of a linear motor is formed at the other end of the arm 66. The voice coil motor 67 includes the driving coil (not shown) wound on the bobbin of the arm 66, and a magnetic circuit including a permanent magnet and counter yoke arranged to oppose each other so as to sandwich the coil.

The arm 66 is held by ball bearings (not shown) formed in two, upper and lower portions of a fixed shaft, and rotated by the voice coil motor 67. That is, the voice coil motor 67 controls the position of the slider 64 on the magnetic disk 62. Note that reference numeral 61 denotes a housing in FIG. 5.

The embodiments will be explained in more detail below by way of their examples.

### Example 1 and Comparative Examples 1 to 9

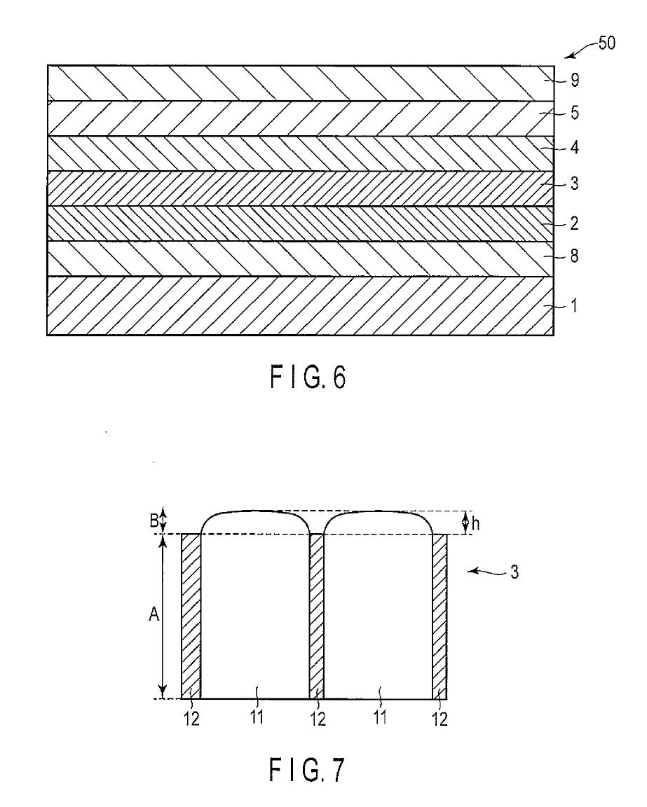

FIG. 6 is an exemplary sectional view showing a perpendicular magnetic recording medium according to Example 1 and Comparative Examples 1 to 9.

A nonmagnetic glass substrate 1 (amorphous substrate MEL6 manufactured by KONICA MINOLTA, diameter=2.5 inches) was placed in a deposition chamber of a DC magnetron sputtering apparatus (C-3010 manufactured by CANON ANELVA), and the deposition chamber was evacuated to an ultimate vacuum degree of 1×10⁻⁵ Pa.

Ar gas was supplied into the deposition chamber so that the gas pressure was 0.7 Pa, and 10-nm thick Cr-25 at % Ti was formed as an adhesive layer 8 on the substrate 1 at a DC power of 500 W.

Then, 40-nm thick Co-20 at % Fe-7 at % Ta-5 at % Zr was formed as a soft magnetic under layer 2 at an Ar pressure of 0.7 Pa and a DC power of 500 W.

5-nm thick Ag-60 at % Ge film was formed as a nonmagnetic seed layer 3 at an Ar pressure of 0.1 Pa and a DC power of 100 W.

15-nm thick Ru was formed as a nonmagnetic interlayer 4 at an Ar pressure of 0.7 Pa and a DC power of 500 W.

After that, 12-nm thick Co-18 at % Pt-14 at % Cr-10 mol % SiO₂ was formed as a perpendicular magnetic recording layer 5 at an Ar pressure of 0.7 Pa and a DC power of 500 W.

Subsequently, a 2.5-nm thick diamond-like carbon (DLC) protective layer 9 was formed by chemical vapor deposition (CVD).

Finally, the resultant structure was coated with a lubricant (not shown) by dipping, thereby obtaining a perpendicular magnetic recording medium 50 according to the embodiment of the present invention.

A perpendicular magnetic recording medium according to Comparative Example 1 was obtained following the same procedures as for the medium of Example 1, except that no nonmagnetic seed layer was deposited.

Also, perpendicular magnetic recording media according to Comparative Examples 2 to 8 were obtained following the same procedures as for the medium of Example 1, except that the material and deposition pressure of the nonmagnetic seed layer and the material of the nonmagnetic interlayer were changed as shown in Table 1 (to be presented later).

Furthermore, a perpendicular magnetic recording medium according to Comparative Example 9 was obtained following the same procedures as for the medium of Example 1, except that no nonmagnetic interlayer 4 was deposited.

As shown in FIG. 6, the media of Example 1 and Comparative Examples 2 to 8 had an arrangement in which the layers were stacked in the following order.

Nonmagnetic glass substrate 1/CrTi adhesive layer 8/CoFeTaZr soft magnetic under layer 2/nonmagnetic seed layer 3/nonmagnetic interlayer 4/CoCrPt—SiO₂ perpendicular magnetic recording layer 5/C protective layer 9

The medium of Comparative Example 1 had an arrangement in which the layers were stacked in the following order.

Nonmagnetic glass substrate 1/CrTi adhesive layer 8/CoFeTaZr soft magnetic under layer 2/Ru nonmagnetic interlayer 4/CoCrPt—SiO₂ perpendicular magnetic recording layer 5/C protective layer 9

The medium of Comparative Example 9 had an arrangement in which the layers were stacked in the following order.

Nonmagnetic glass substrate 1/CrTi adhesive layer 8/CoFeTaZr soft magnetic under layer 2/nonmagnetic seed layer 3/CoCrPt—SiO₂ perpendicular magnetic recording layer 5/C protective layer 9

The characteristics of the obtained media of Example 1 and Comparative Examples 1 to 9 were evaluated by analyzing the media as follows.

First, the grain structures in the film plane direction of the nonmagnetic seed layer and perpendicular magnetic recording layer were observed by transmitting electron microscope (TEM) measurement. In addition, the compositions of grains and grain boundaries were analyzed by using energy dispersive X-ray spectroscopy (TEM-EDX).

In the media of Example 1 and Comparative Example 9, the AgGe film as a nonmagnetic seed layer contained crystalline Ag gains having a grain size of about 4 nm, and an amorphous Ge grain boundary having a grain boundary width of about 2 nm.

On the other hand, in the nonmagnetic seed layers of the media of Comparative Examples 2 and 3, the crystal grains were made of Pd and in contact with each other, and the grain boundary width was practically 0.

The nonmagnetic seed layer of the medium of Comparative Example 4 contained crystalline Ag grains having a grain size of about 20 nm, and an amorphous Ge grain boundary having a grain boundary width of about 1 nm.

In the nonmagnetic seed layers of the media of Comparative Examples 5 and 6, the crystal grains were made of Ag and in contact with each other, and the grain boundary width was practically 0.

In the nonmagnetic seed layers of the media of Comparative Examples 7 and 8, the crystal grains were made of AgGe and in contact with each other, and the grain boundary width was practically 0. In the perpendicular magnetic recording layers, the grains were made of crystalline CoCrPt, and the grain boundary was made of amorphous SiO₂, although the grain size and grain size distribution changed from one medium to another.

Then, cross-sectional TEM measurement was performed on the media of Example 1 and Comparative Examples 1 to 9. In the AgGe films as nonmagnetic seed layers of the media of Example 1 and Comparative Example 9, the Ag grain surface had a domed projection whose apex was the central portion of the grain, and had a shape falling from the central portion toward the grain boundary. The height of the projection of the Ag grain was 2.5 nm.

FIG. 7 is an exemplary view showing the sectional structure of the nonmagnetic seed layer.

As shown in FIG. 7, the nonmagnetic seed layer 3 contains Ag grains 11, and a Ge grain boundary 12 formed around the Ag grains 11. The surface of the Ag grain 11 is higher than that of the Ge grain boundary 12. Assuming that a region in which the Ge grain boundary having a predetermined width between the Ag grains 11 exists is a region A in the nonmagnetic seed layer 3, the distance between the Ag grains 11 increases in a region B above the region A. In the example, it was determined that a position at which the distance between the Ag grains 11 started increasing was a lower side, the apex of the grain was an upper side, and a height h of the Ag grain surface from the Ge grain boundary surface was the height of the projection of the Ag grain.

Also, the cross-sectional TEM measurement revealed that one Ru grain (the nonmagnetic interlayer) grew immediately above the Ag grain (the nonmagnetic seed layer), and one CoCrPt grain (the perpendicular magnetic recording layer) grew immediately above the Ru grain. In this structure, the Ag grains in the nonmagnetic seed layer, the Ru grains in the nonmagnetic interlayer, and the CoCrPt grains in the perpendicular magnetic recording layer grew in one-to-one correspondence with each other.

On the other hand, in the medium of Comparative Example 9 having no nonmagnetic interlayer, one CoCrPt grain generally existed on one Ag grain near the interface between the nonmagnetic seed layer and perpendicular magnetic recording layer, but the CoCrPt grains grew in various directions, and many grains connected to each other.

In the media of Comparative Examples 1 to 8, the crystal grains in the nonmagnetic seed layer were flat. In the medium of Comparative Example 4, for example, the height of the Ag grain surface from the Ge grain boundary surface was less than 1 nm. In the media of Comparative Examples 2, 3, and 5 to 8, the grain boundary width was practically 0 as described above. It was determined that in this structure in which the grains were in contact with each other with no grain boundary between them, a position where the grains started separating from each other was a lower side, the apex of the grain was an upper side, and the distance between the lower side and upper side was the height of the projection of the grain. In the media of Comparative Examples 1 to 8, one Ru grain (the nonmagnetic interlayer) did not necessarily exist on one grain of the nonmagnetic seed layer; a place where one Ru grain existed and a place where two Ru grains existed were mixed. On the other hand, one CoCrPt grain (the perpendicular magnetic recording layer) grew on one Ru grain (the nonmagnetic interlayer). This shows that the grain structure of the nonmagnetic seed layer was not transferred to the Ru nonmagnetic interlayer and CoCrPt—SiO₂ perpendicular magnetic recording layer.

Also, grain size analysis was performed on the medium of Example 1 and the nonmagnetic seed layers and perpendicular magnetic recording layers of Comparative Examples 1 to 9 by the following procedure by using the results of planar TEM measurement.

From planar TEM images taken at magnifications of ×500,000 to ×2,000,000, an arbitrary image including at least 100 grains was loaded as image information into a computer. The contours of the individual crystal grains were extracted by performing image processing on this image information.

Then, a diameter connecting two points on the outer circumference of the crystal grain and passing the center of gravity was measured at every 2°, and the average value of these diameters was measured as the crystal grain size of the crystal grain, thereby obtaining the average grain size and grain size distribution. The grain size distribution represents the degree of grain size variation by a percentage. Also, the grain boundary width was obtained by measuring a grain boundary width on a line connecting the centers of gravity of grains, and calculating the average value of the measured widths.

Table 1 below shows the results of the grain size analysis of Example 1 and Comparative Examples 1 to 9.

TABLE 1

| | | | | | | | Perpendicular magnetic | | | |
|---|---|---|---|---|---|---|---|---|---|---|
| | Nonmagnetic seed layer | | | | | | recording layer | | | |
| | | Crystal | Average | Grain | Ag grain | | | Average | Grain | |
| | Material | grain | grain | size | surface | Nonmagnetic | | grain | size | |
| | (Deposition | (Oriented | size | distribution | layer height | interlayer | Δθ50 | size | distribution | SNR |
| | pressure) | plane) | (nm) | (%) | (nm) | material | (deg) | (nm) | (%) | (dB) |
| Example 1 | Ag-60% Ge | Ag | 4 | 12 | 25 | Ru | 2.8 | 5 | 13 | 23.5 |
| | (0.1 Pa) | (111) | | | | | | | | |
| Comparative | — | — | — | — | — | Ru | 13.4 | 16 | 37 | 9.5 |
| Example 1 | | | | | | | | | | |
| Comparative | Pd | Pd | 12 | 31 | 0 | Ru | 4.5 | 8 | 23 | 17.7 |
| Example 2 | (0.7 Pa) | (111) | | | | | | | | |
| Comparative | Pd | Pd | 14 | 33 | 0 | Ru | 4.1 | 10 | 24 | 15.9 |
| Example 3 | (0.1 Pa) | (111) | | | | | | | | |
| Comparative | Ag-60% Ge | Ag | 20 | 39 | <1 | Ru | 6.8 | 12 | 29 | 10.1 |
| Example 4 | (0.7 Pa) | (111) | | | | | | | | |
| Comparative | Ag | Ag | 14 | 34 | <1 | Ru | 7.3 | 9 | 24 | 13.3 |
| Example 5 | (0.7 Pa) | (111) | | | | | | | | |
| Comparative | Ag | Ag | 16 | 36 | <1 | Ru | 6.6 | 11 | 25 | 11.7 |
| Example 6 | (0.1 Pa) | (111) | | | | | | | | |
| Comparative | Ag-75% Ge | AgGe | 13 | 38 | 0 | Ru | 8.7 | 12 | 28 | 12.8 |
| Example 7 | (0.7 Pa) | (00.2) | | | | | | | | |
| Comparative | Ag-75% Ge | AgGe | 13 | 38 | 0 | Co-40% | 9.3 | 14 | 29 | 11.6 |
| Example 8 | (0.7 Pa) | (00.2) | | | | Cr | | | | |
| Comparative | Ag-60% Ge | Ag | 4 | 12 | 25 | — | 15.1 | 12 | 30 | 10.5 |
| Example 9 | (0.1 Pa) | (111) | | | | | | | | |

In the medium of Example 1, the average grain size and grain size distribution of the Ag grains in the nonmagnetic seed layer were almost equal to those of the perpendicular magnetic recording layer. That is, it was possible to transfer the grain structure of the AgGe film to the CoCrPt—SiO₂ perpendicular magnetic recording layer.

On the other hand, in the media of Comparative Examples 2 to 8, the grain structure of the nonmagnetic seed layer could not be transferred to the perpendicular magnetic recording layer as described previously.

In the medium of Comparative Example 9, the grains of the perpendicular magnetic recording layer connected to each other, so the grain structure of the nonmagnetic seed layer could not be transferred to the perpendicular magnetic recording layer, as described previously. As shown in Table 1, the grain size distribution of the medium of Example 1 was better than that of the medium of any comparative example.

Then, the crystal orientation (Δθ50) of the perpendicular magnetic recording layer of each of these media was checked by measuring the rocking curve by using an X-ray diffraction (XRD) apparatus (Xpert-MRD manufactured by Spectris). The results were as shown in Table 1. The Δθ50 of the perpendicular magnetic recording layer of the medium of Example 1 was 2.8°, indicating that the crystallinity of the medium was better than those of the media of Comparative Examples 1 to 9. When an ordinary metal was deposited at a low Ar pressure as in Comparative Examples 3 and 6 in the same manner as in Example 1, the crystallinity improved, but the grains connected to each other because the crystal planes between the grains were aligned. Consequently, the crystal grain size increased.

The results of Comparative Example 4 reveal that even when the same AgGe film as the nonmagnetic seed layer of Example 1 was used, if the film was deposited at a normal deposition pressure of 0.7 Pa, the grain size distribution and crystal orientation largely worsened. This indicates that when the deposition pressure was changed, the AgGe nonmagnetic seed film could not achieve the same grain size distribution decreasing effect as that of the medium of this application.

Also, when using 25 at % Ag-75 at % Ge, the AgGe grains had an hcp structure instead of the Ag grains and Ge grain boundary, so the same effect as that of the medium of this application was not obtained. In the medium of Comparative Example 9, the oriented planes were not aligned and the Δθ50 worsened because the grains grew as they inclined.

Subsequently, the recording/reproduction characteristics of these media were evaluated. The recording/reproduction characteristics were measured using read/write analyzer RWA1632 and spinstand S1701MP manufactured by GUZIK, U.S.A. That is, the recording/reproduction characteristics were measured at a linear recording density of 1,400 kBPI as a recording frequency condition by using a head including a shielded magnetic pole that was a single magnetic pole with a shield (the shield had a function of converging a magnetic flux output from a magnetic head) as a writing unit, and a TMR element as a reproducing unit. Table 1 shows the results. The medium of Example 1 had a value of 23.5 dB, i.e., exhibited a favorable recording/reproduction characteristic. As shown in Table 1, the recording/reproduction characteristic of the medium of Example 1 was better than those of the media of Comparative Examples 1 to 9.

In the medium of Example 1 as described above, it was possible to obtain a film having a low grain size distribution by depositing the AgGe film at an Ar pressure lower than the normal pressure. Also, the Ag grain surface had a height of 2.5 nm from the Ge grain boundary surface in the AgGe nonmagnetic seed layer.

Since the Ag grain surface of the AgGe film had a height of 2.5 nm from the grain boundary surface, the Ru grains of the interlayer and the CoCrPt grains of the recording layer grew on the Ag grains in one-to-one correspondence with each other. This made it possible to transfer the grain structure of the AgGe nonmagnetic seed layer having a low grain size distribution to the CoCrPt—SiO₂ perpendicular magnetic recording layer, thereby obtaining a perpendicular magnetic recording layer having a low grain size distribution. Since this reduces the transition noise, favorable recording/reproduction characteristics can be achieved.

### Example 2 to 5 and Comparative Examples 10 to 12

Magnetic recording media were obtained following the same procedures as in Example 1 except that each nonmagnetic underlayer shown in Table 2 below was formed between a nonmagnetic seed layer and nonmagnetic interlayer. That is, a 5-nm thick nonmagnetic underlayer made of each material shown in Table 2 below was formed on the nonmagnetic seed layer at an Ar pressure of 0.7 Pa and a DC power of 500 W.

TEM measurement, XRD measurement, and recording/reproduction characteristic evaluation were performed on these media in the same manner as in Example 1.

Table 2 below shows the obtained results.

TABLE 2

| | | Perpendicular magnetic | | | |
|---|---|---|---|---|---|
| | | recording layer | | | |
| | Nonmagnetic | | Average | | |
| | under | | grain | Grain size | |
| | layer | Δθ50 | size | distribution | SNR |
| | material | (deg) | (nm) | (%) | (dB) |
| Example 1 | — | 2.8 | 5 | 13 | 23.5 |
| Example 2 | Pd | 2.8 | 5 | 11 | 23.8 |
| Example 3 | Ta | 2.8 | 5 | 11 | 23.9 |
| Example 4 | Co—30% Cr | 2.8 | 5 | 12 | 23.7 |
| Example 5 | Ni—10% W | 2.8 | 5 | 12 | 23.7 |
| Comparative | Cr | 5.8 | 14 | 28 | 14.8 |
| Example 10 | | | | | |
| Comparative | Pt | 3.8 | 11 | 26 | 16.4 |
| Example 11 | | | | | |
| Comparative | Cu—20% Ti | 4.2 | 12 | 25 | 15.5 |
| Example 12 | | | | | |

As shown in Table 2, when the nonmagnetic underlayer containing an element selected from Pd, Ta, Co, and Ni as a main component was formed, the grain size distribution of a perpendicular magnetic recording layer was further improved from that in Example 1. As a consequence, it was possible to improve the recording/reproduction characteristics.

The media of Examples 2 to 5 and Comparative Examples 10 to 12 had an arrangement in which layers were stacked in the following order, and had the same arrangement as that shown in FIG. 6 except that a nonmagnetic underlayer 6 was formed between the nonmagnetic seed layer 3 and nonmagnetic interlayer 4.

Nonmagnetic glass substrate 1/CrTi adhesive layer 8/CoFeTaZr soft magnetic under layer 2/AgGe nonmagnetic seed layer 3/nonmagnetic underlayer 6/Ru nonmagnetic interlayer 4/CoCrPt—SiO₂ perpendicular magnetic recording layer 5/C protective layer 9

### Examples 6 to 8 and Comparative Examples 13 and 14

Media were obtained following the same procedures as in Example 1 except that each nonmagnetic orientation control layer shown in Table 3 below was formed between a soft magnetic under layer and nonmagnetic seed layer. That is, a 5-nm thick nonmagnetic orientation control layer 9 made of each material shown in Table 3 was formed on the soft magnetic under layer at an Ar pressure of 0.7 Pa and a DC power of 500 W.

TEM measurement, XRD measurement, and recording/reproduction characteristic evaluation were performed on these media in the same manner as in Example 1.

Table 3 below shows the obtained results.

TABLE 3

| | | Perpendicular magnetic recording | | | |
|---|---|---|---|---|---|
| | | layer | | | |
| | Nonmagnetic | | Average | | |
| | orientation | | grain | Grain size | |
| | control layer | Δθ50 | size | distribution | SNR |
| | material | (deg) | (nm) | (%) | (dB) |
| Example 1 | — | 2.8 | 5 | 13 | 23.5 |
| Example 6 | Ag | 2.6 | 5 | 13 | 23.7 |
| Example 7 | Pd | 2.5 | 5 | 13 | 23.8 |
| Example 8 | Ru | 2.7 | 5 | 13 | 23.6 |
| Comparative | Cu | 3.5 | 5 | 17 | 19.8 |
| Example 13 | | | | | |
| Comparative | Al | 3.8 | 5 | 18 | 19.4 |
| Example 14 | | | | | |

As shown in Table 3, when the nonmagnetic orientation control layer containing an element selected from Ag, Pd, and Ru as a main component was formed, the crystal orientation of a perpendicular magnetic recording layer was further improved from that in Example 1. As a consequence, it was possible to improve the recording/reproduction characteristics.

The media of Examples 6 to 8 and Comparative Examples 13 and 14 had an arrangement in which layers were stacked in the following order, and had the same arrangement as that shown in FIG. 6 except that a nonmagnetic orientation control layer 7 was formed between the soft magnetic under layer 2 and nonmagnetic seed layer 3.

Nonmagnetic glass substrate 1/CrTi adhesive layer 8/CoFeTaZr soft magnetic under layer 2/nonmagnetic orientation control layer 7/AgGe nonmagnetic seed layer 3/Ru nonmagnetic interlayer 4/CoCrPt—SiO₂ perpendicular magnetic recording layer 5/C protective layer 9

### Examples 9 to 12

Media were obtained following the same procedures as in Example 1 except that each nonmagnetic orientation control layer shown in Table 4 below was formed between a soft magnetic under layer and nonmagnetic seed layer, and each nonmagnetic underlayer shown in Table 4 was formed between the nonmagnetic seed layer and a nonmagnetic interlayer. That is, a 5-nm thick nonmagnetic orientation control layer made of each material shown in Table 4 was formed on the soft magnetic under layer at an Ar pressure of 0.7 Pa and a DC power of 500 W. In addition, a 5-nm thick nonmagnetic underlayer made of each material shown in Table 2 was formed on the nonmagnetic seed layer at an Ar pressure of 0.7 Pa and a DC power of 500 W.

TEM measurement, XRD measurement, and recording/reproduction characteristic evaluation were performed on these media in the same manner as in Example 1.

Table 4 below shows the obtained results.

TABLE 4

| | Non- | | Perpendicular magnetic | | | |
|---|---|---|---|---|---|---|
| | magnetic | Non- | recording layer | | | |
| | orientation | magnetic | | Average | | |
| | control | under | | grain | Grain size | |
| | layer | layer | Δθ50 | size | distribution | SNR |
| | material | material | (deg) | (nm) | (%) | (dB) |
| Example 1 | — | — | 2.8 | 5 | 13 | 23.5 |
| Example 9 | Ag | Pd | 2.6 | 5 | 11 | 24.0 |
| Example | Ag | Ta | 2.6 | 5 | 11 | 24.1 |
| 10 | | | | | | |
| Example | Pd | Pd | 2.5 | 5 | 11 | 24.1 |
| 11 | | | | | | |
| Example | Pd | Ta | 2.5 | 5 | 11 | 24.2 |
| 12 | | | | | | |

As shown in Table 4, when the nonmagnetic orientation control layer and nonmagnetic underlayer were formed, the crystal orientation and grain size distribution of a perpendicular magnetic recording layer were further improved from those in Example 1. As a consequence, it was possible to improve the recording/reproduction characteristics.

The media of Examples 9 to 12 had an arrangement in which layers were stacked in the following order, and had the same arrangement as that shown in FIG. 6 except that a nonmagnetic orientation control layer 7 was formed between the soft magnetic under layer 2 and nonmagnetic seed layer 3, and a nonmagnetic underlayer 6 was formed between the nonmagnetic seed layer 3 and nonmagnetic interlayer 4.

Nonmagnetic glass substrate 1/CrTi adhesive layer 8/CoFeTaZr soft magnetic under layer 2/nonmagnetic orientation control layer 7/AgGe nonmagnetic seed layer 3/nonmagnetic underlayer 6/Ru nonmagnetic interlayer 4/CoCrPt—SiO₂ perpendicular magnetic recording layer 5/C protective layer 9

### Example 13

Media were obtained following the same procedures as in Example 1 except that a nonmagnetic seed layer was formed by using an Ag—Ge target in which the composition amount of Ge in the nonmagnetic seed layer was changed from 30 to 85 at %.

TEM measurement and recording/reproduction characteristic evaluation were performed on these media in the same manner as in Example 1.

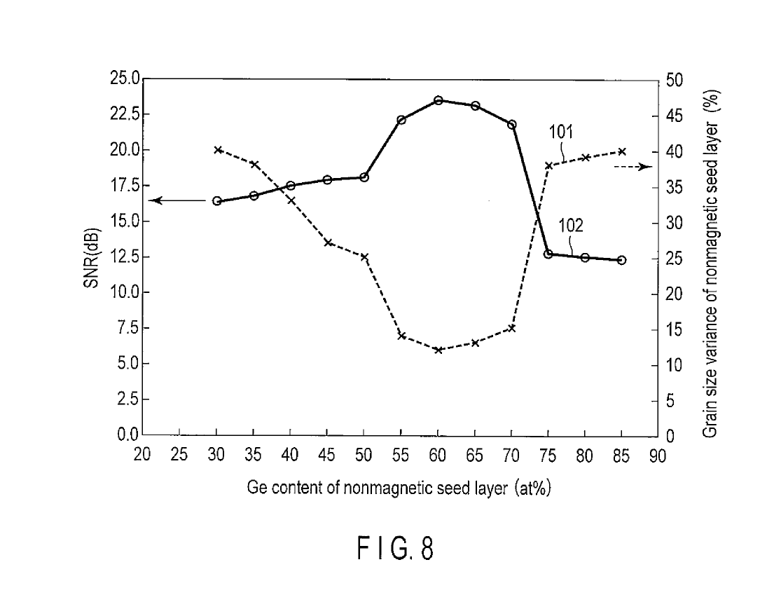

FIG. 8 is a graph showing a curve 101 indicating the relationship between the Ge composition amount and grain size distribution in the nonmagnetic seed layer, and a curve 102 indicating the relationship between the Ge content in the nonmagnetic seed layer and the SNR.

As shown in FIG. 8, the grain size distribution and recording/reproduction characteristics improved especially when the Ge content was 55 to 70 at %.

### Examples 14 and 15 and Comparative Examples 15 and 16

Media of Examples 14 and 15 of this application and media of Comparative Examples 15 and 16 were obtained following the same procedures as in Example 1, except that a nonmagnetic seed layer was formed by changing the pressure from 0.01 to 1.0 Pa. Note that the result at 0.01 Pa is not described because the Ar pressure was too low to discharge electricity during sputtering and no film was deposited.

TEM measurement, XRD measurement, and recording/reproduction characteristic evaluation were performed on these media in the same manner as in Example 1.

Table 5 below shows the obtained results.

TABLE 5

| | | | | | Perpendicular magnetic | | | |
|---|---|---|---|---|---|---|---|---|
| | Nonmagnetic seed layer | | | | recording layer | | | |
| | | Average | Grain | Ag grain | | Average | Grain | |
| | Material | grain | size | surface layer | | grain | size | |
| | (Deposition | size | distribution | height | Δθ50 | size | distribution | SNR |
| | pressure) | (nm) | (%) | (nm) | (deg) | (nm) | (%) | (dB) |
| Example 14 | Ag-60% Ge | 3 | 12 | 2.5 | 2.8 | 4 | 14 | 23.5 |
| | (0.05 Pa) | | | | | | | |
| Example 1 | Ag-60% Ge | 4 | 12 | 2.5 | 2.8 | 5 | 13 | 23.5 |
| | (0.1 Pa) | | | | | | | |
| Example 15 | Ag-60% Ge | 5 | 14 | 2.2 | 2.9 | 6 | 15 | 22.4 |
| | (0.3 Pa) | | | | | | | |
| Comparative | Ag-60% Ge | 18 | 35 | <1 | 6.2 | 10 | 26 | 15.3 |
| Example 15 | (0.5 Pa) | | | | | | | |
| Comparative | Ag-60% Ge | 20 | 39 | <1 | 6.8 | 12 | 29 | 10.1 |
| Example 4 | (0.7 Pa) | | | | | | | |
| Comparative | Ag-60% Ge | 21 | 40 | <1 | 7 | 12 | 29 | 9.8 |
| Example 16 | (1.0 Pa) | | | | | | | |

As shown in Table 5, when the deposition pressure was 0.05 to 0.3 Pa, the grain size distributions and recording/reproduction characteristics were better than those of the media of the comparative examples.

### Example 16 and Comparative Examples 17 and 18

Media of Example 16 of this application and Comparative Examples 17 and 18 were obtained following the same procedures as in Example 1, except that a perpendicular magnetic recording layer was formed using Fe-50 at % Pt-10 mol % SiO₂.

Table 6 below shows the obtained results.

TEM measurement, XRD measurement, and recording/reproduction characteristic evaluation were performed on these media in the same manner as in Example 1. As shown in Table 6, the medium of the example had a low grain size distribution and good recording/reproduction characteristics.

TABLE 6

| | | | | | | | Perpendicular | | | |
|---|---|---|---|---|---|---|---|---|---|---|
| | | | | | | | magnetic | | | |
| | Nonmagnetic seed layer | | | | | | recording layer | | | |
| | | Crystal | Average | Grain | Ag grain | | | Average | Grain | |
| | Material | grain | grain | size | surface layer | Nonmagnetic | | grain | size | |
| | (Deposition | (Orientation | size | distribution | height | interlayer | Δθ50 | size | distribution | SNR |
| | pressure) | plane) | (nm) | (%) | (nm) | material | (deg) | (nm) | (%) | (dB) |
| Example 16 | Ag-60% Ge | Ag | 4 | 12 | 2.5 | Ru | 2.9 | 6 | 14 | 22.6 |
| | (0.1 Pa) | (111) | | | | | | | | |
| Comparative | Pd | Pd | 15 | 32 | 0 | Ru | 4.5 | 8 | 23 | 16.9 |
| Example 17 | (0.7 Pa) | (111) | | | | | | | | |
| Comparative | Ag-60% Ge | Ag | 4 | 12 | 2.5 | — | 16.3 | 14 | 36 | 13.6 |
| Example 18 | (0.1 Pa) | (111) | | | | | | | | |

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A perpendicular magnetic recording medium comprising:
a nonmagnetic substrate,
a soft magnetic under layer on the nonmagnetic substrate,
a nonmagnetic seed layer on the soft magnetic under layer, the nonmagnetic seed layer comprising a silver germanium layer containing silver grains having an fcc structure and an amorphous germanium grain boundary formed around the silver grains, a surface of the silver grain being higher than a surface of the germanium grain boundary,
a nonmagnetic interlayer on the nonmagnetic seed layer, the nonmagnetic interlayer comprising ruthenium or a ruthenium alloy, and
a perpendicular magnetic recording layer on the nonmagnetic interlayer, the perpendicular magnetic recording layer comprising cobalt, or iron and platinum.

2. The medium according to claim 1, wherein the silver grain surface is at least 2 nm higher than the germanium grain boundary surface.

3. The medium according to claim 2, wherein the silver grain surface is 2 to 3 nm higher than the germanium grain boundary surface.

4. The medium according to claim 1, further comprising a nonmagnetic underlayer containing, as a main component, at least one element selected from the group consisting of palladium, tantalum, cobalt, and nickel, the nonmagnetic underlayer between the nonmagnetic seed layer and the nonmagnetic interlayer.

5. The medium according to claim 1, further comprising a nonmagnetic orientation control layer containing, as a main component, at least one element selected from the group consisting of silver, palladium, and ruthenium, the nonmagnetic orientation control layer between the soft magnetic under layer and the nonmagnetic seed layer.

6. The medium according to claim 1, wherein a germanium content in the nonmagnetic seed layer is 55 to 70 at %.

7. The medium according to claim 1, wherein the nonmagnetic seed layer is a silver germanium layer deposited in an argon ambient at an argon pressure of 0.05 to 0.3 Pa.

8. A magnetic recording/reproduction apparatus comprising:
a perpendicular magnetic recording medium including a nonmagnetic substrate,
a soft magnetic under layer on the nonmagnetic substrate,
a nonmagnetic seed layer on the soft magnetic under layer, the nonmagnetic seed layer comprising a silver germanium layer containing silver grains having an fcc structure and an amorphous germanium grain boundary formed around the silver grains, a surface of the silver grain being higher than a surface of the germanium grain boundary,
a nonmagnetic interlayer on the nonmagnetic seed layer, the nonmagnetic interlayer comprising ruthenium or a ruthenium alloy,
a perpendicular magnetic recording layer on the nonmagnetic interlayer, the perpendicular magnetic recording layer comprising cobalt or iron and platinum,
a mechanism configured to support and rotate the perpendicular magnetic recording medium,
a magnetic head comprising an element configured to record information on the perpendicular magnetic recording medium and an element configured to reproduce recorded information, and
a carriage assembly supporting the magnetic head such that the magnetic head can freely move with respect to the perpendicular magnetic recording medium.

9. The apparatus according to claim 8, wherein the silver grain surface is at least 2 nm higher than the germanium grain boundary surface.

10. The apparatus according to claim 9, wherein the silver grain surface is 2 to 3 nm higher than the germanium grain boundary surface.

11. The apparatus according to claim 8, further comprising a nonmagnetic underlayer containing, as a main component, at least one element selected from the group consisting of palladium, tantalum, cobalt, and nickel, the nonmagnetic underlayer between the nonmagnetic seed layer and the nonmagnetic interlayer.

12. The apparatus according to claim 8, further comprising a nonmagnetic orientation control layer containing, as a main component, at least one element selected from the group consisting of silver, palladium, and ruthenium, the nonmagnetic orientation control layer between the soft magnetic under layer and the nonmagnetic seed layer.

13. The apparatus according to claim 8, wherein a germanium content in the nonmagnetic seed layer is 55 to 70 at %.

14. The apparatus according to claim 8, wherein the nonmagnetic seed layer is a silver germanium layer deposited in an argon ambient at an argon pressure of 0.05 to 0.3 Pa.
